(19) United States
(12) Patent Application Publication
(10) Pub. No.: US 2009/0004906 A1
(43) Pub. Date: Jan. 1, 2009

(54) Electrical Connector Having Cam Locking Features

(75) Inventors: Richard M. Koch, Wakefield, MA (US); Anthony Martiniello, Wilmington, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Tru Corporation, Peabody, MA (US)

(21) Appl. No.: 12/163,120

(22) Filed: Jun. 27, 2008

Related U.S. Application Data
(60) Provisional application No. 60/947,134, filed on Jun. 29, 2007.

(51) Int. Cl. H01R 13/627; H01R 9/05; H01R 43/20

(52) U.S. Cl. 439/352; 439/583; 29/747

(57) ABSTRACT

An electrical connector including a jack including an external peripheral groove, a jack center conductor and a jack outer conductor; and a plug configured to receive the jack, the plug including a locking member, a plug center conductor and a plug outer conductor. The external peripheral groove is configured to receive the locking member and the locking member is configured to engage the peripheral groove. The jack center conductor and the plug center conductor are in electrical contact with each other and the jack outer conductor and the plug outer conductor are in contact with each other when the locking member is in engagement with the peripheral groove.

### CROSS-REFERENCE TO RELATED APPLICATIONS

This application claims the benefit of the filing date of U.S. Provisional Application Ser. No. 60/947,134, filed Jun. 29, 2007, which is hereby fully incorporated by reference

### TECHNICAL FIELD

The present invention relates in general to electrical connectors and, in particular, to a cable connector including cam locking features.

### BACKGROUND

Coaxial cable is widely used in various industries, and the construction of such cables is well known. Generally, a coaxial cable includes a center conductor for transmitting signals. The center conductor is surrounded by a dielectric insulator material, which is itself surrounded by a metallic outer conductor. The outer conductor is often a braided wire shielding. Conventionally, the outer braided shielding is also covered by an insulating jacket.

Coaxial transmission line cable is typically electrically and mechanically coupled to other cables or equipment using end connectors known for the purpose. While the exact arrangement of coaxial connectors varies to some degree, generally a connector may include a conductive metal body and a center conductor electrically isolated from the body. The cable may be stripped to expose the cable center conductor. The cable center conductor may then be soldered or crimped to a center conductor of the connector. Once the cable center conductor is soldered to the center conductor of the connector, the cable braid may be mechanically secured and/or electrically coupled to the connector body, such as by a shrink-wrap dielectric installed over the braid. A coaxial cable having a connector end may be coupled to a mating connector using a coupling nut that engages a threaded portion of the mating connector.

### BRIEF DESCRIPTION OF THE DRAWINGS

The advantages of the present invention are described with reference to particular exemplary embodiments thereof, which description should be understood in conjunction with the accompanying illustrations, wherein:

FIG. 1 is a side sectional view of one exemplary embodiment of a jack portion of an electrical connector consistent with the present disclosure;

FIG. 2 is a side sectional view of one exemplary embodiment of a plug portion of an electrical connector consistent with the present disclosure;

FIG. 3 is a side sectional view of the jack and plug portions of FIGS. 1 and 2 in a mated configuration;

FIG. 4 is a side view of the jack portion of FIG. 1;

FIG. 5 is a side view of the plug portion of FIG. 2;

FIG. 6 is a side view of the jack and plug portions of FIGS. 1 and 2 in a mated configuration;

FIGS. 7-9 illustrate another exemplary embodiment of an electrical connector assembly consistent with the present disclosure;

FIGS. 10-12 illustrate exemplary embodiments of pin and/or socket electrical contact portions with spring contacts useful in a connector assembly consistent with the present disclosure;

FIGS. 13-15 illustrate another exemplary embodiment of an electrical connector assembly consistent with the present disclosure useful in connection with a typical EIA-1625 electrical interface shown in FIG. 13;

FIGS. 16 and 17 illustrate an exemplary pin-lock embodiment consistent with the present disclosure; and

FIGS. 18 and 19 illustrate an exemplary slide-lock embodiment consistent with the present disclosure.

### DETAILED DESCRIPTION

For simplicity and ease of explanation, the present invention will be described herein in connection with various exemplary embodiments thereof. Those skilled in the art will recognize that the features and advantages of the present invention may be implemented in a variety of configurations. It is to be understood, therefore, that the embodiments described herein are presented by way of illustration, not of limitation.

The present disclosure relates to an electrical connector for connecting coaxial transmission lines. The coaxial transmission line may be rigid or flexible, e.g., coaxial cable. The electrical connector may provide for “blind mating” of connectors where one or both connectors may not be visible and the connection may be accomplished by feel. The electrical connector may further provide engagement and locking mechanisms to facilitate engagement and locking of the connectors relatively quickly and easily. The electrical connector may allow insertion of a jack into a plug without initial alignment and may then guide the insertion to provide final, locked alignment. For example, a locking mechanism may include a cam locking mechanism and/or may bias the connectors in an engaged condition.

In the figures, like elements have like reference designators.

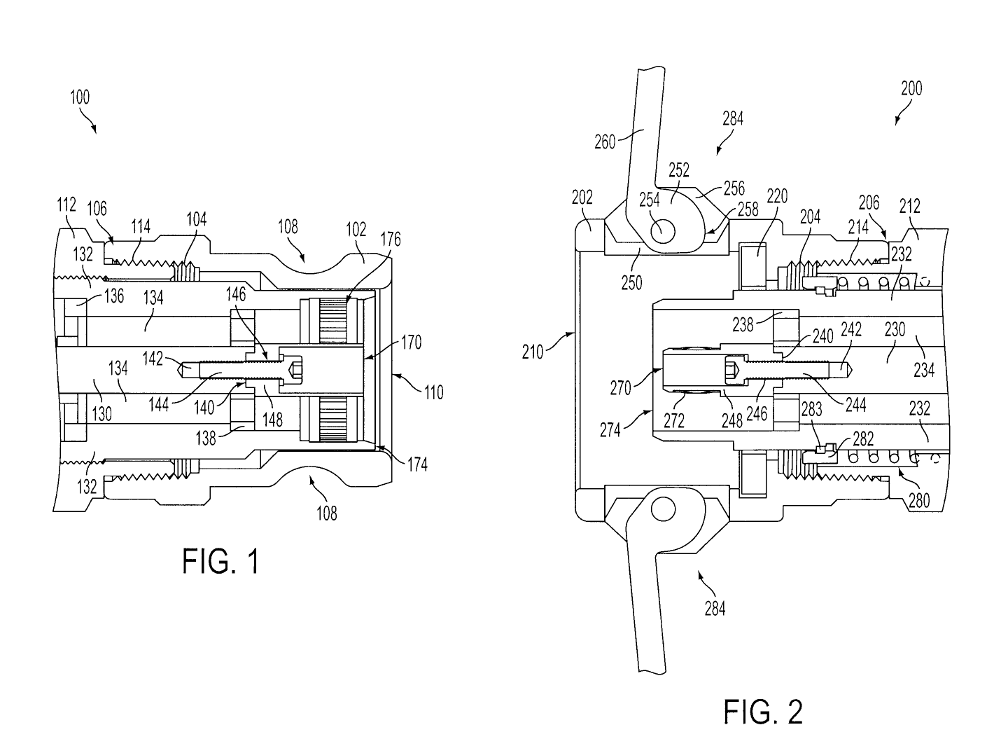

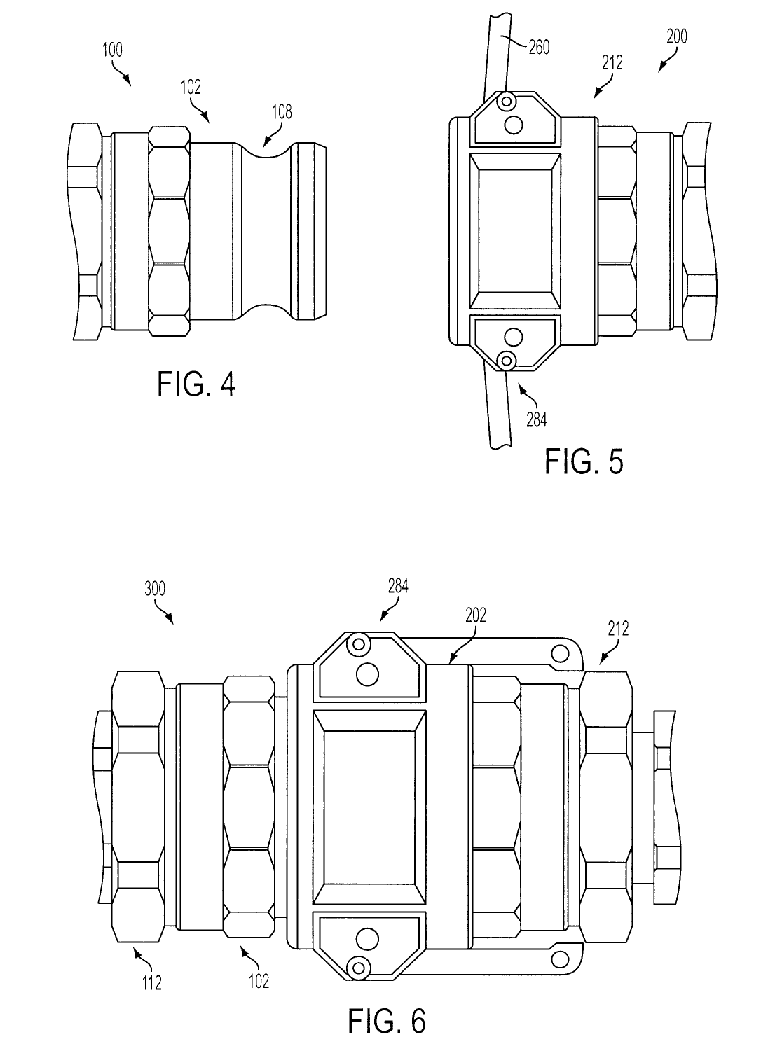

FIGS. 1-6 illustrate jack 100 and plug 200 portions of a connector assembly 300 consistent with the present disclosure. In the illustrated exemplary embodiment, the jack 100 has an outer shell portion 102 with internal threads 104 adjacent a second end 106 and a peripheral locking groove 108 adjacent a first end 110. The jack 100 may further include an inner shell portion 112 with external threads 114. The jack 100 outer shell portion 102 may thereby be configured to be coupled to the jack 100 inner shell portion 112. The outer shell portion 102 of the jack 100 may be configured to be inserted into a first end 210 of an outer shell portion 202 of the plug 200. The plug 200 may be internally threaded 204 at its second end 206. The plug 200 may include a compliant member 220, e.g., a gasket or o-ring that may be configured to contact, and be compressed by, the jack 100 outer shell portion 102 when the jack 100 is inserted into the plug 200. The plug 200 may further include an inner shell portion 212 with external threads 214. The plug outer shell portion 202 may thereby be configured to be coupled to the plug inner shell portion 212. The plug outer shell portion 202 may define opposed side openings 250 positioned to be opposite the peripheral groove 108 in jack outer shell portion 102 when the jack 100 is inserted in the plug 200. Associated with each opening 250 may be a cam member 252 which is pivotally mounted on a pin 254 fixedly secured to a pair of ears 256 integral with outer shell portion 202 of the plug 200. Each cam member 252 has a cam portion 258 which may be pivoted about the pin 254 into and out of engagement with locking groove 108 using an integral locking lever 260.

The outer shell portions 102, 202 may be commercially available coupling configurations, such as the KAMLOK™ couplings available from Pride Cast Metals, Inc. of Cincinnati, Ohio, or may be configured as shown, for example, in U.S. Pat. No. 4,295,670, the teachings of which are hereby incorporated herein by reference. In general, the outer shell portions may be constructed according to U.S. Military specification MIL-C-27487. The outer shell portions 102, 202 may be provided in a range of sizes, e.g. 0.5 inch to 8 inch, and may be constructed from aluminum, brass, stainless steel, nylon, polypropylene, etc.

The jack 100 and plug 200 may include associated electrical conductor portions and insulator portions. In particular, the jack 100 and plug 200 may each include a center conductor 130, 230, and an outer conductor 132, 232. Each center conductor 130, 230, may be separated from its associated outer conductor 132, 232 by an insulating dielectric layer 134, 234. In an embodiment, the dielectric may be air. The insulating dielectric layer 134, 234 may further include an insulating support, e.g., dielectric/insulator 136 and/or insulator/support 138, 238, that may maintain an axial position of the center conductor 130, 230, relative to the outer conductor 132, 232. The center conductor 130, 230, outer conductor 132, 232, and dielectric layer 134, 234, may be generally centrally located in apertures in the inner 112, 212, and outer shell portions 102, 202.

The center conductors 130, 230, may each have an end 140, 240. Each center conductor 130, 230 may define an axial cavity 142, 242, that extends from the end 140, 240 of the center conductor. The axial cavity 142, 242, may be configured to receive a threaded member 144, 244, e.g., a screw. For example, the axial cavity 142, 242, may include a threaded portion 146, 246. The axial cavity 142, 242, may have a length that is at least a length of a threaded portion of the threaded member 144, 244. The jack center conductor 130 may include a socket electrical contact portion 148 and the plug center conductor 230 may include a pin electrical contact portion 248. The socket electrical contact portion 148 may be configured to receive the pin electrical contact portion 248. For example, the pin electrical contact portion 248 may be configured to be inserted into the socket electrical contact portion 148. Each electrical contact portion 148, 248, may be configured to be fixedly attached to its associated center conductor 130, 230, by the threaded member 144, 244, for example.

The electrical contact portions 148, 248, may each have an end 170, 270. The end 170 of the jack socket electrical contact portion may be adjacent the first end 110 of the jack outer shell portion. The end 270 of the plug pin electrical contact portion may be recessed in the plug outer shell portion 202, i.e., the end 270 of the plug pin electrical contact portion may be axially positioned between the first end 210 and the second end 206 of the plug outer shell portion 202 thus facilitating aligning the jack 100 and plug 200 for coupling.

In an embodiment, the plug pin electrical contact portion 248 may further include a center spring contact 272. The center spring contact 272 may be positioned adjacent the end 270 of the pin electrical contact portion about an outer surface of the pin electrical contact portion 248. The center spring contact 272 may be configured to be compressed when the pin electrical contact portion 248 is inserted in the socket electrical contact portion 148. The center spring contact 272 may enhance electrical contact, i.e., conductivity, between the pin 248 and the socket 148 when the jack 100 and plug 200 are mated together while allowing ease of coupling.

The jack outer conductor 132 may have an end 174. The end 174 of the jack outer conductor may be positioned adjacent the first end 110 of the jack outer shell portion. The jack outer conductor 132 may include an outer spring contact adjacent 176 its end 174, about an inner surface of the jack outer conductor 132. The outer spring contact 176 may be configured to be compressed when the plug outer conductor 232 is inserted in the jack outer conductor 132. The outer spring contact 176 may enhance electrical contact, i.e., conductivity, between the jack outer conductor 132 and the plug outer conductor 232 when the jack 100 and plug 200 are mated together.

The plug 200 may further include a compression spring 280. For example, the compression spring 280 may be a coil spring. The compression spring 280 may be positioned about the plug outer conductor 232, adjacent the inner shell portion 212. The compression spring 280 may be held in place by a spring retainer 282 and the inner shell portion 212. The spring retainer 282 may include a key 283 for communicating a spring force to the plug outer conductor 232. The compression spring 280 may be configured to be compressed when the plug 200 is coupled to the jack 100. The compression spring 280 may fix the jack outer conductor 132 in contact with the plug outer conductor 232 when the jack 100 is locked to the plug 200.

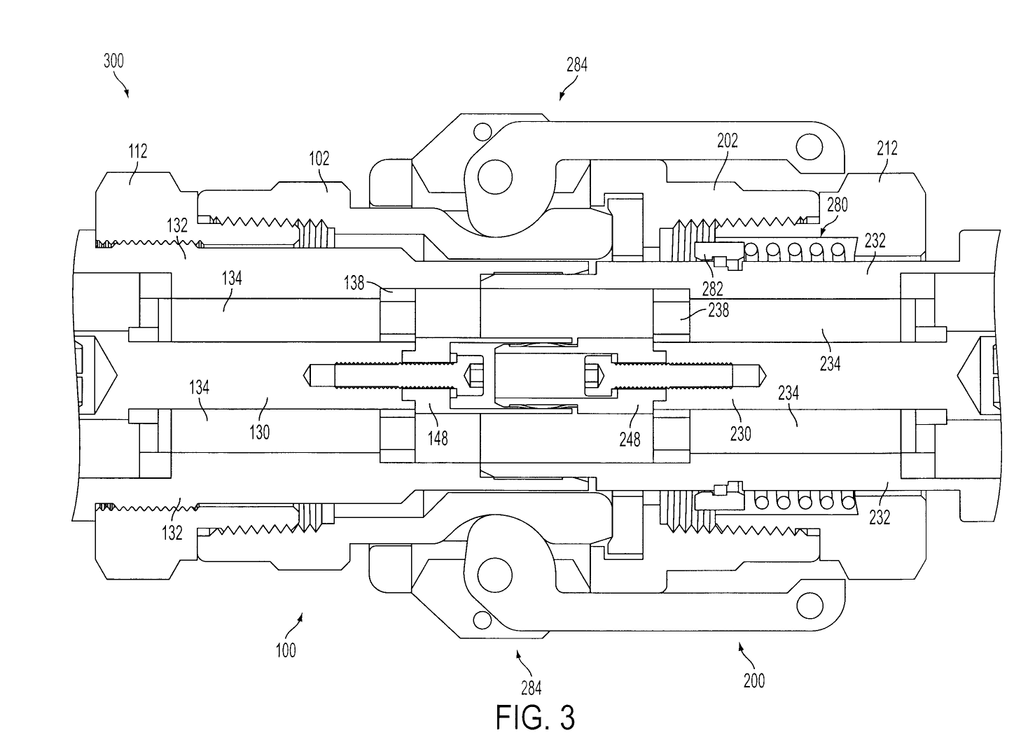

To couple the jack 100 and plug 200, jack outer shell portion 102 may be inserted into plug outer shell portion 202 with cam members 252 in the elevated position shown in FIG. 2. When the jack outer shell portion 102 is fully inserted into plug outer shell portion 212, cam member levers 260 may be rotated on pins 254 to carry each cam portion 258 into engagement with locking groove 108 to lock jack 100 and socket 200 together, as shown in FIG. 3. In this position the jack 100 and plug 200 are securely locked to each other with a reliable microwave or RF connection established between the center conductor portions 130, 230 and between the outer conductor portions 132, 232. In this position, socket 148 and pin 248 electrical contact portions may be in electrical contact with each other, the outer conductors 132, 232, may be in electrical contact with each other, compression spring 280 may be compressed, and jack outer shell portion 102 may be in contact with the compliant member 220. Disconnecting the jack 100 and plug 200 portions may be accomplished simply by rotating the levers 260 to remove the cams 258 from the locking groove 108 and axially forcing the jack 100 and plug 200 apart.

The jack 100 and plug 200 portions may allow and accommodate initial misalignment during coupling. For example, in certain situations, either or both the plug 200 and the jack 100 portions may not be visible so that the coupling may be accomplished by feel. In such a situation, it may be difficult, if not impossible, to reliably align the jack 100 and plug 200 portions, e.g., for coupling threaded members. A jack 100 and plug 200, consistent with the present disclosure, may accommodate this potential misalignment during coupling and ensure alignment when the jack 100 and plug 200 are “locked”. For example, the jack 100 is not configured to be threadably coupled to the plug 200 so there may be no opportunity for cross-threading. The center 272 and outer spring contacts 176 may allow misalignment during coupling and may maintain alignment once the jack 100 and plug 200 are coupled. The cam members 252 and peripheral locking groove 108 may provide a positive lock between the jack 100 and plug 200. The compression spring 280 may be compressed when the jack 100 and plug 200 are coupled and may thereby bias the plug outer conductor 232 to maintain contact with the jack outer conductor 132.

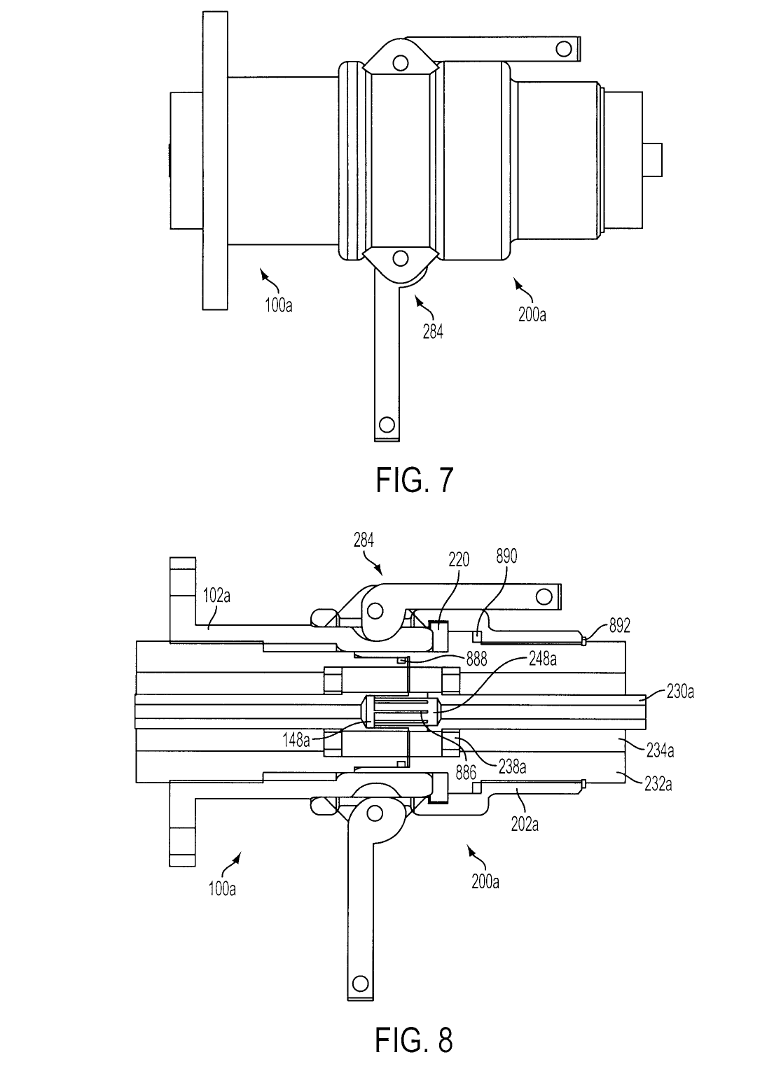

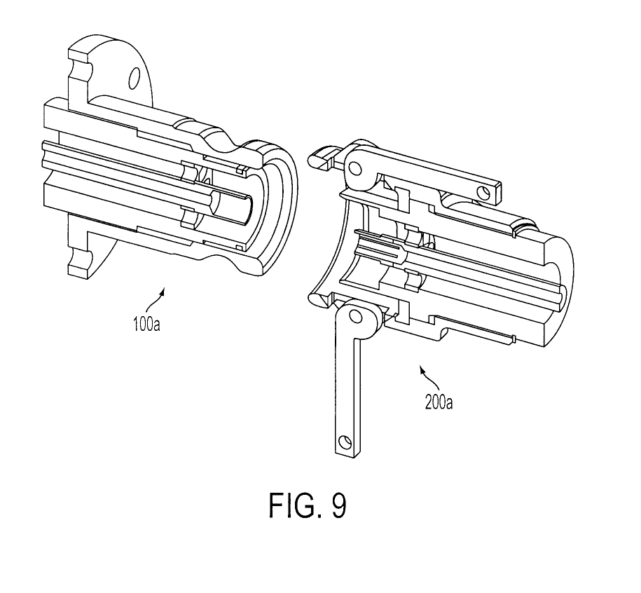

FIGS. 7-9 illustrate another exemplary embodiment 700 of an electrical connector assembly consistent with the present disclosure. Similar to the embodiments discussed above, this embodiment may include a jack 100a with a socket electrical contact portion 148a and a plug 200a with a pin electrical contact portion 248a, configured with a cam locking feature 284. In this embodiment, the pin electrical contact portion 248a may include one or more axial slits 886 distributed about its circumference. The slits 886 may be configured to provide a compliant interference fit between the pin electrical contact portion 248a and the socket electrical contact portion 148a.

The jack outer conductor 132a may further include an electrical contact spring 888 adjacent its end. The electrical contact spring 888 may provide a compliant interference fit between the jack and plug outer conductors 132a, 232a. The plug 200a may include a compliant ring 890 between its outer shell portion 202a and outer conductor 232a. The compliant ring 890 may function similar to the compression spring, e.g., compression spring 280, discussed above. The plug outer shell portion 202a may include a retaining ring 892, configured to couple the outer conductor 232a to the outer shell portion 202a.

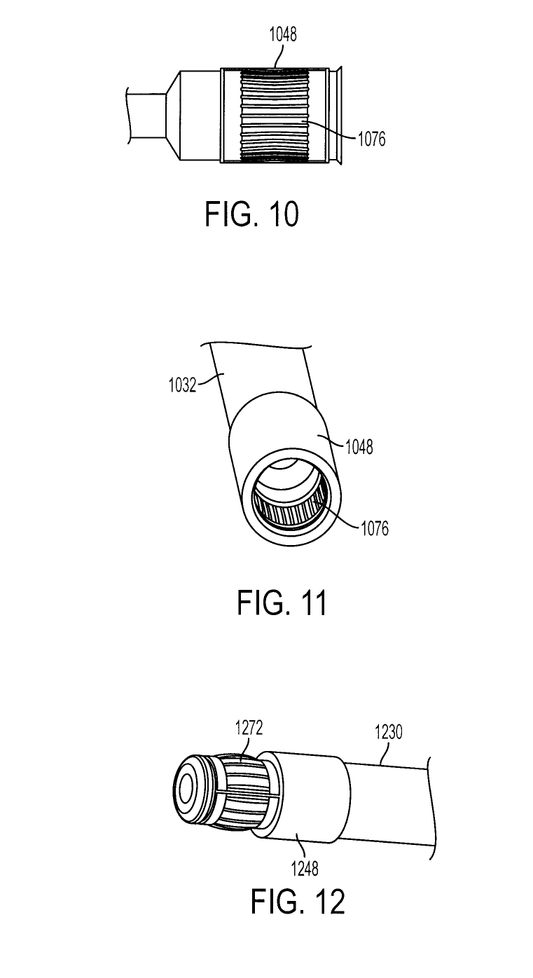

FIGS. 10-12 illustrate exemplary embodiments of pin and/or socket electrical contact portions with spring contacts that may be useful in a connector assembly consistent with the present disclosure. FIGS. 10 and 11 illustrate examples of a conductor 1032 with a socket electrical contact portion 1048 and outer spring contacts 1076. The conductor 1032 may be an inner and/or an outer conductor. FIG. 12 illustrates an example of a center conductor 1230 with a pin electrical contact portion 1248 and center spring contacts 1272.

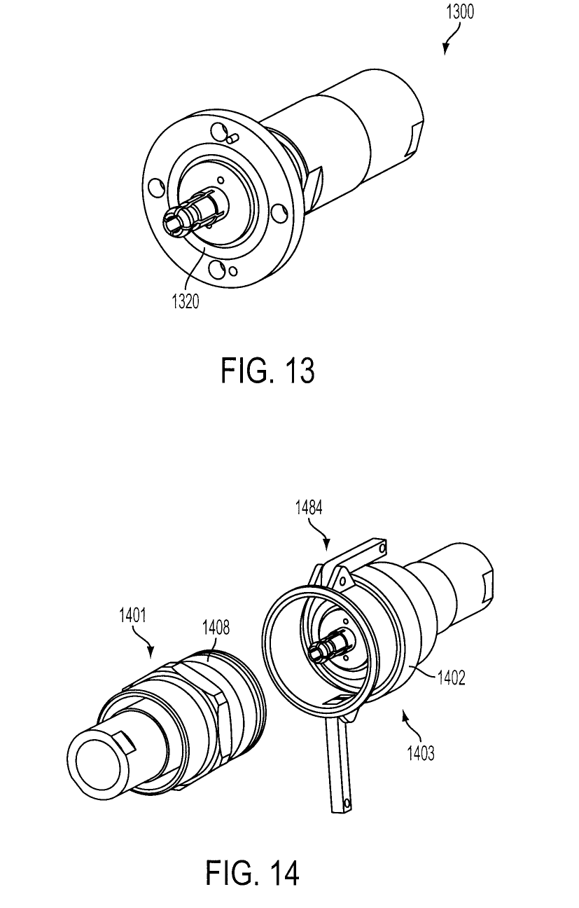

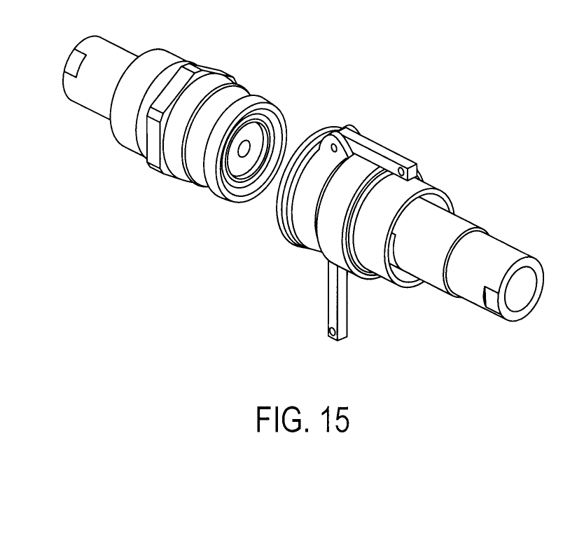

FIGS. 13-15 illustrate another exemplary embodiment 1400 of an electrical connector assembly consistent with the present disclosure that may be useful in connection with a typical EIA-1625 electrical interface 1300 shown in FIG. 13. In this embodiment, a plug outer shell portion 1402 may be coupled to the EIA-1625 electrical interface 1300. The EIA-1625 electrical interface 1300 may include a compliant ring 1320 which may provide a compliant seal between the jack 1401 and plug 1403. As discussed above, the plug 1403 may be configured with a cam locking feature 1484 and the jack 1401 may be configured with a peripheral locking groove 1408.

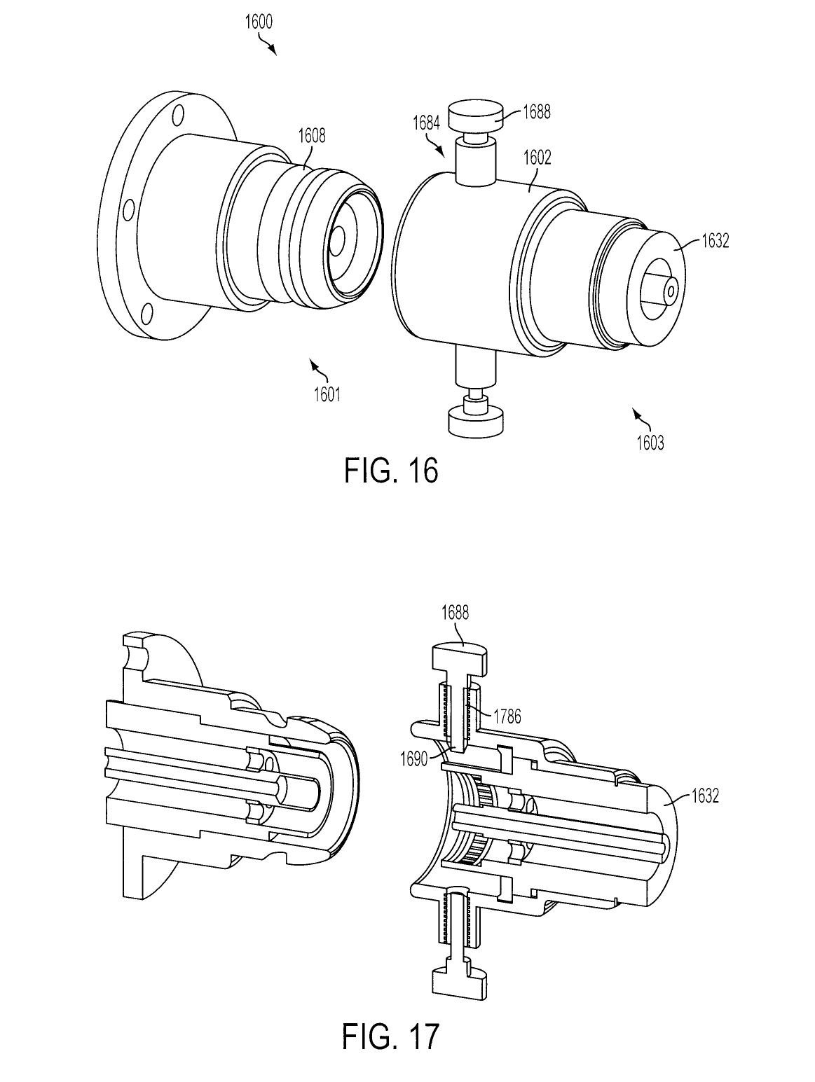

FIGS. 16 and 17 illustrate an exemplary pin-lock embodiment 1600 consistent with the present disclosure. In this embodiment, the cam-locking feature, e.g., cam-locking feature 284, discussed above may be replaced by a pin locking feature 1684. A plug 1603 may include an outer shell portion 1602 that defines a radial aperture 1786. In an embodiment, the outer shell portion 1602 may further include a second opposing radial aperture 1786a. Each aperture 1786, 1786a, may be configured to receive a locking pin 1688. An end of the locking pin 1690 may be configured to extend beyond an inner surface of the outer shell portion 1602 toward an outer conductor 1632. The end of the locking pin 1690 may contact the peripheral locking groove 1608 when the jack 1601 and plug 1603 are coupled. The locking pin 1688 may be retracted from its locking position, so that the end 1690 does not extend into the peripheral locking groove, to allow coupling and/or decoupling of the jack 1601 and plug 1603. The locking pin 1688 may be coupled to the outer shell portion 1602 by an extension spring, for example, so that the locking pin 1688 is biased to extend toward the outer conductor 1632. The locking pin 1688 may be configured to retract, away from the outer conductor 1632 as the jack 1601 is inserted into the plug 1603. The locking pin 1688 may then extend into the peripheral groove 1608 to lock the jack 1601 and plug 1603.

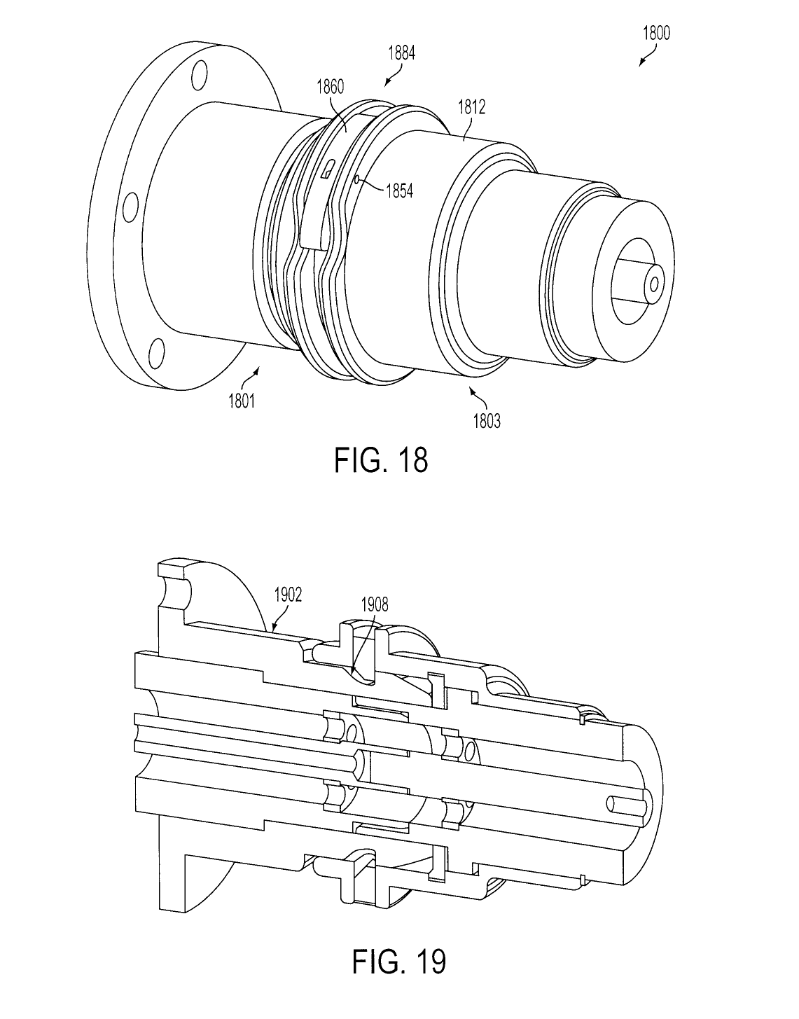

FIGS. 18 and 19 illustrate an exemplary slide-lock embodiment consistent with the present disclosure. In this embodiment, the cam locking feature 284 discussed above may be replaced by a side-lock feature 1884. The side-lock feature 1884 may include a lever 1860, pivotably mounted to a plug outer shell portion 1812 by a pivot pin 1854. The lever 1860 may be configured to engage with a locking groove 1908 in a jack outer shell portion 1902. A long axis of the lever 1860 may be parallel to an interface between the jack 1801 and the plug 1803. This configuration may result in a relatively more compact electrical connector 1800.

According to one aspect of the disclosure, there is provided an including: a jack including an external peripheral groove, a jack center conductor and a jack outer conductor; and a plug configured to receive the jack, the plug including a locking member, a plug center conductor and a plug outer conductor. The external peripheral groove is configured to receive the locking member and the locking member is configured to engage the peripheral groove. The jack center conductor and the plug center conductor are in electrical contact with each other and the jack outer conductor and the plug outer conductor are in contact with each other when the locking member is in engagement with the peripheral groove.

According to another aspect of the disclosure, there is provided a system including: a coaxial transmission line including a center conductor and an outer conductor wherein the center conductor and the outer conductor are separated by a dielectric layer; an electrical connector coupled to the coaxial transmission line, the electrical connector including: a jack including an external peripheral groove, a jack center conductor and a jack outer conductor; and a plug configured to receive the jack, the plug including a locking member, a plug center conductor and a plug outer conductor. The external peripheral groove is configured to receive the locking member and the locking member is configured to engage the peripheral groove. The jack center conductor and the plug center conductor are in electrical contact with each other and the jack outer conductor and the plug outer conductor are in contact with each other when the locking member is in engagement with the peripheral groove.

According to yet another aspect of the disclosure, there is provided a method of coupling an electrical connector, the method including: providing a jack including an external peripheral groove, a jack center conductor and a jack outer conductor; providing a plug configured to receive the jack, the plug including a locking member, a plug center conductor and a plug outer conductor; coupling the jack and the plug; and engaging the locking member in the peripheral groove, wherein the jack center conductor and the plug center conductor are in electrical contact with each other and the jack outer conductor and the plug outer conductor are in contact with each other when the locking member is in engagement with the peripheral groove.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. An electrical connector comprising:
a jack comprising an external peripheral groove, a jack center conductor and a jack outer conductor; and
a plug configured to receive said jack, said plug comprising a locking member, a plug center conductor and a plug outer conductor,
wherein said external peripheral groove is configured to receive said locking member and wherein said locking member is configured to engage said peripheral groove,
wherein said jack center conductor and said plug center conductor are in electrical contact with each other and said jack outer conductor and said plug outer conductor are in contact with each other when said locking member is in engagement with said peripheral groove.

2. The electrical connector of claim 1 further comprising a compression spring, wherein said compression spring is configured to bias said plug outer conductor against said jack outer conductor.

3. The electrical connector of claim 1 wherein said locking member comprises a cam member, a locking pin member or a side locking member.

4. The electrical connector of claim 1 wherein said jack center conductor comprises a socket electrical contact portion and said plug center conductor comprises a pin electrical contact portion.

5. The electrical connector of claim 4 wherein said pin electrical contact portion further comprises a center spring contact.

6. The electrical connector of claim 1 wherein said jack outer conductor further comprises an outer spring contact.

7. The electrical connector of claim 4 wherein said pin electrical contact portion further comprises an axial slot.

8. A system comprising:
a coaxial transmission line comprising a center conductor and an outer conductor wherein said center conductor and said outer conductor are separated by a dielectric layer; and
an electrical connector coupled to said coaxial transmission line, said electrical connector comprising:
a jack comprising an external peripheral groove, a jack center conductor and a jack outer conductor; and
a plug configured to receive said jack, said plug comprising a locking member, a plug center conductor and a plug outer conductor,
wherein said external peripheral groove is configured to receive said locking member and wherein said locking member is configured to engage said peripheral groove,
wherein said jack center conductor and said plug center conductor are in electrical contact with each other and said jack outer conductor and said plug outer conductor are in contact with each other when said locking member is in engagement with said peripheral groove.

9. The system of claim 8 wherein said electrical connector further comprises a compression spring, wherein said compression spring is configured to bias said plug outer conductor against said jack outer conductor.

10. The system of claim 8 wherein said locking member comprises a cam member, a locking pin member or a side locking member.

11. The system of claim 8 wherein said jack center conductor comprises a socket electrical contact portion and said plug center conductor comprises a pin electrical contact portion.

12. The system of claim 11 wherein said pin electrical contact portion further comprises a center spring contact.

13. The system of claim 8 wherein said jack outer conductor further comprises an outer spring contact.

14. The system of claim 11 wherein said pin electrical contact portion further comprises an axial slot.

15. A method of coupling an electrical connector, said method comprising:
providing a jack comprising an external peripheral groove, a jack center conductor and a jack outer conductor;
providing a plug configured to receive said jack, said plug comprising a locking member, a plug center conductor and a plug outer conductor;
coupling said jack and said plug; and
engaging said locking member in said peripheral groove, wherein said jack center conductor and said plug center conductor are in electrical contact with each other and said jack outer conductor and said plug outer conductor are in contact with each other when said locking member is in engagement with said peripheral groove.

16. The method of claim 15 further comprising biasing said plug outer conductor against said jack outer conductor with a compression spring.

17. The method of claim 15 further comprising engaging said peripheral groove with a cam member, a locking pin member or a side locking member.

18. The method of claim 15 wherein coupling said jack and said plug further comprises coupling a socket electrical contact portion and a pin electrical contact portion.

19. The method of claim 18 wherein said pin electrical contact portion further comprises a center spring contact.

20. The method of claim 15 wherein said jack outer conductor further comprises an outer spring contact.
